(19) United States
(12) Patent Application Publication
(10) Pub. No.: US 2013/0054595 A1
(43) Pub. Date: Feb. 28, 2013

(54) Automated File Name Generation

(71) Applicant: ABBYY Software Ltd., Nicosia (CY)

(72) Inventors: Andrey Isaev, Moscow (RU); Vasiliy Panferov, Moscow (RU)

(73) Assignee: ABBYY Software Ltd., Nicosia (CY)

(21) Appl. No.: 13/662,044

(22) Filed: Oct. 26, 2012

Related U.S. Application Data
(63) Continuation-in-part of application No. 12/749,525, filed on Mar. 30, 2010.
Application No. 12/749,525 is a continuation-in-part of application No. 12/236,054, filed on Sep. 23, 2008, now Pat. No. 8,260,049.
(60) Provisional application No. 60/976,348, filed on Sep. 28, 2007.

(51) Int. Cl. G06F 17/30

(52) U.S. Cl. 707/736; 707/E17.005

(57) ABSTRACT

Described herein are methods for determining a type and unique features of a document. The methods generally include generating at least one document hypothesis corresponding to the type of the document. For each document hypothesis, the document type is verified. A best type hypothesis is selected. A document name is formed based on the best type hypothesis and one or more unique features of the document. Such steps are generally included in automatically or programmatically naming of documents. A unique or semi-unique name is given, one that reproduces some of the document's contents, attributes and/or characteristics. Each document is provided with a name that can be easily understood and that is related to the content of the document.

### CROSS-REFERENCE TO RELATED APPLICATIONS

For purposes of the USPTO extra-statutory requirements, the present application constitutes a continuation-in-part of U.S. patent application Ser. No. 12/749,525, which is a continuation-in-part of U.S. patent application Ser. No. 12/236,054 titled “Model-Based Method of Document Logical Structure Recognition in OCR Systems that was filed on 23 Sep. 2008, which is currently co-pending, or is an application of which a currently co-pending application is entitled to the benefit of the filing date. Patent application Ser. No. 12/236,054 claims the benefit of priority to U.S. 60/976,348 which was filed on 28 Sep. 2007.

The United States Patent Office (USPTO) has published a notice effectively stating that the USPTO's computer programs require that patent applicants reference both a serial number and indicate whether an application is a continuation or continuation-in-part. See Stephen G. Kunin, Benefit of Prior-Filed Application, USPTO Official Gazette 18 Mar. 2003. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### BACKGROUND OF THE INVENTION

1. Field

Embodiments of the present invention are directed towards the implementation of optical character recognition (OCR) and intelligent character recognition OCR (ICR) that is capable of handling documents.

2. Description of the Related Art

Computer users regularly need to work with images of documents. Document images originate from a variety of sources including scanners, photographs generated by mobile phones, cameras, and email messages, either as attachments or as embedded images. Generally, these images must be saved somewhere for future access to them. Over time, there are a lot of document images. The question naturally arises, how to find a particular document quickly?

OCR systems are known to transform images of paper documents into a computer-readable and computer-editable form which is searchable. OCR systems may also be used to extract data from such images. OCR systems output plain text, which typically has a simplified layout and formatting. However, only certain aspects of documents are retained such as paragraphs, fonts, font styles, font sizes, and some other simple properties of the source document.

One of the solutions to overcome this limitation of typical OCR systems is to enable keyword searches of the previously recognized text of documents. Each new incoming document is recognized, indexed and added to these systems. When something must be found, keywords may be used to get a list of documents containing these words.

But keyword search is only one of the ways of facilitation of finding documents. Another option is to give each document a name that briefly reproduces its essence, a name that includes some text. Usually, users do not create a file name manually, or when they do, it is only for particularly important documents. Users typically save documents into a single store, and over time accumulate documents with names such as, “image_{—}0001.jpg”, and “21082008.pdf”, making recollection of their contents and searches for particular or important documents almost impossible.

There is a further problem that occurs in processing batches of images automatically. When a user loads or scans a batch of images into an OCR application, the output is typically a batch of documents with recognized data. In this case, the output documents are typically named according to a generic pattern, for example: “Document0001,” “Document0002,” etc. The resulting documents may be sent to the user by e-mail or placed in a pre-defined folder.

Another problematic scenario occurs during recognition of newspaper or magazine pages with several articles on a page. In this scenario, it is difficult or impossible to separate one story from another, and the result from the OCR process is typically of an unacceptable quality.

If a user regularly recognizes large numbers of documents, the result may be a multitude of files with similar-looking meaningless names in the user's mail box or pre-defined folder. Checking these files against their paper counterparts and renaming these files involves a significant amount of manual work and substantial loss of time to meaningless repetitive tasks.

### SUMMARY

In one embodiment, the invention provides a method for determining the type of a document and its unique features. The method comprises generating at least one document hypothesis for corresponding to the type of the document. For each document hypothesis, the method further comprises verifying said document type hypothesis, selecting a best type hypothesis, and forming a document name based on the best type hypothesis and one or more unique features.

This application describes methods of automatically naming documents. Each document taken through this system receives a unique or semi-unique name that reproduces some of the document's contents, attributes and/or characteristics. As a result of work of described technology a range of the user's documents each of which has the name by which one can understand that he is contained in a document is forming.

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings.

FIG. 1 shows examples of sources of data for tags.

FIG. 2 shows an example of a particular type of document (recipe) from which to extract data for tags.

FIG. 3 shows an example of another particular type of document (business card) from which to extract data for tags.

FIG. 4A shows a flowchart in accordance with one embodiment of the invention.

FIG. 4B shows a flowchart for a detailed algorithm of a method in accordance with one embodiment of the invention.

FIG. 4C shows a flowchart for a method in accordance with another embodiment of the invention.

FIG. 5 shows a data structure and set of data derived from a representation of a document or image in accordance with one embodiment of the invention.

FIG. 6 shows a data structure derived from a representation of a file (document or image) in accordance with another embodiment of the invention.

FIG. 7 shows a variety of document types that may be derived from data associated or derived from a representation of a document in accordance with an embodiment of the invention.

FIG. 8 shows a block diagram of a hardware device for performing methods, in accordance with embodiments of the invention.

### DETAILED DESCRIPTION

A scanned or photographed image of a document can serve as input information. A document image can be one or more pages. An image that includes “vector” information about the disposition and content of text and graphic elements can also be used as input information. For example, a document image can be a portable document format (PDF) file with a text layer, a vector-based PDF file, an XPS-type file, a DOCX-type file, an XSLX-type file, a plain text (TXT) file, etc.

A document page, for example a newspaper page or magazine page, may include several different articles with separate titles, inserts, pictures, etc. In accordance with embodiments of the present invention, a result of performing optical character recognition (OCR) or intelligent character recognition (ICR) is an editable text-encoded document that replicates the logical structure, layout, formatting, etc. of the original paper document or document image that was fed to the system.

A text string briefly reflecting content of a document can be used as the file name of the document. Such a useful file name is a result of the methods described herein. “File name string” is the term used for this string herein. Certain structural elements of a document, their order and spatial relationships, and certain keywords or unique features in titles or in other parts of the document may sometimes be used to compose a file name string. For example, the file name string can include information about a type or category describing the document (e.g., letter, business card). The file name string also can include information from “tags” inside the document (e.g., date, address, names).

“Tags” is the term used herein to describe keywords and unique features of a document as described more fully below. Tags are small parts of a text reflecting a document's properties. For example, the name of an author of a document, the date of writing, the name, and the header can be used as a tag.

Each tag may comprise a type (for example: a header) and value (for example: “Tag extraction”). Several examples of types are illustrative: a header, a running title, a page number, a quotation, a date of purchase (such as from a bank statement, receipt), a date that a contract was executed, a url, and an e-mail address.

The tags result from an analysis of a document. At its simplest, the tag can be found in a text (e.g., text string, body of text) of the document. In more sophisticated cases, one or more tags for a document can be calculated or generated on the basis of data contained in the document—hidden data, metadata, format data and data in the content of the document. Also the tag can be generated from data received or queried from additional sources of knowledge outside of the document. For example, one can find the name of an author of a book by performing a search such as using an Internet search provider. In another case, the name of a book can be recognized from a barcode in an image or photo of the book's cover.

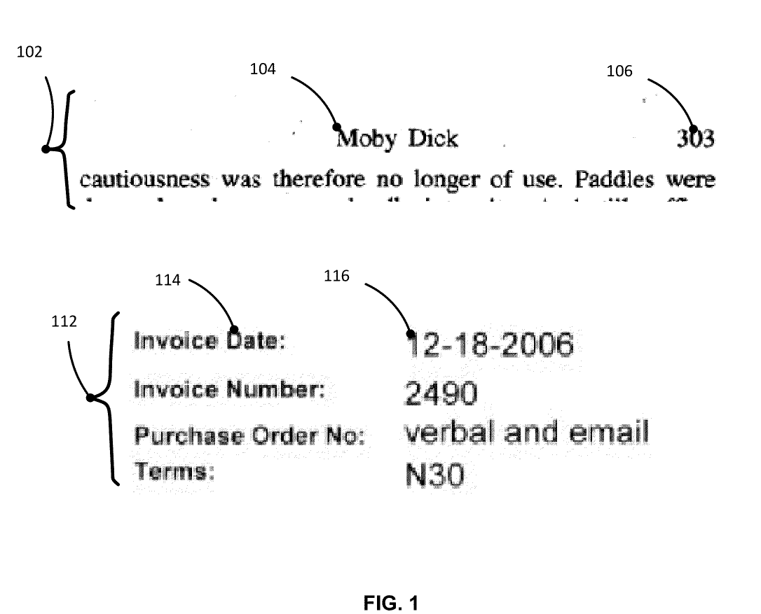

FIG. 1 shows examples of sources of data for tags. With reference to FIG. 1, a top of a page of a book 102 is shown. A title 104 and a page number 106 appear on the top of each page of the corpus of the book. The title 104 and/or the page number 106 can serve as a tag or portion of a tag. A running title may serve as a tag itself, and may serve as the document name. Also additional data, for example date, page number, book name, author's name and the like, can be found inside the running title, and such information may be used as a tag or portion thereof. One or more tags, or portions thereof, may be combined and used to generate a name of a document.

Also shown in FIG. 1 is a portion 112 of an invoice. One or more keywords or labels 114 can serve as a tag or portion of a tag (e.g., Invoice Date, Invoice Number). The actual keyword data 116 (e.g., “12-18-2006” for invoice date and “2490” for invoice number) can serve as a tag or portion of a tag. For the portion 112 of the invoice, a tag could be “invoice number 2490”.

Even features of text, text-based and non-text-based elements can serve as tags or portions of tags—or may be used to identify elements that can serve as such. For example, font size and relative text location may be used. Running titles, such as the one shown in FIG. 1, are usually located separate from the main document text on each page. Headings are usually located in a centered location and are in a different font than other text on a page. Dates are another example. Dates sometimes have a special formatting and include a day and year. Date-connected tags can be found using these and other relevant features. Telephone numbers include some specific features, too. For example, “(509) 624-0026” includes a set of parentheses with three numbers inside, and a dash between groups of numbers. In another example, “+44 (0) 114 249 9888” includes a set of parentheses, a plus sign, and strategically located spaces between a particular number of numbers (e.g., spaces between groups of 2, 3 or 4 digits).

Sources external to the text or text elements may be used to generate or locate text or data that may then be the source of a tag or portion thereof. For example, a QR barcode with an encoded URL may be found in an image of a document. A tag generation algorithm may include recognizing this QR barcode, decoding the associated URL, accessing a Web page at the URL, and retrieving information from a header of the accessed Web page.

In yet another embodiment, a telephone number may be found in the document. A tag or portion thereof may be generated by using an external phone book or database of telephone numbers, searching for and locating the number, and retrieving a name of a company associated with the telephone number. In another embodiment, a telephone number may be called and a recording made subsequent to the call reaching a destination (e.g., an automated greeting message of a company); subsequently, a voice to text procedure may be performed, and the text derived from or based on such text may be used as a tag or portion thereof.

In yet another example, when a quotation appears in an image of a document, the quotation may be used to derive the name, birthdate, etc. of its author may be used as a tag or portion thereof.

In another example, if a postal ZIP code appears in an image of a document, the ZIP code may be used to derive an associated city, state or other information that may then be used as a tag or portion thereof. For a ZIP code in the United States of America, a ZIP code of 10118 could be used to derive “Empire State Building” in New York City, of

In another example, suppose a URL and other text appears at the top of a page of a document (such as from a printing to a PDF document from a Web browser). As an example, suppose that http://www.ibsen.net/?id=1430 30.09.2008” appears along the top of one or more pages of a document. A tag extracting function or functionality may identify the date (i.e., 30.09.2008) and domain name (i.e., ibsen.net). In this case, these two tags could be combined to form a name of the document, e.g., “ibsen_net_{—}1430_{—}2008-09-30.” These data can be processed and used as the tags all together or independently of each other.

A file name string can also be generated at the time of document conversion (e.g., renaming; subjected to OCR, saved and renamed). Such generation may be embedded in or may operate in conjunction with functions of the operating system or file browser (e.g., file explorer). For example, suppose a file has the name “picture_{—}001.jpg”; this file can be saved as “Letter_from_John_{—}30.Aug.12.pdf” when processing is completed. A file browser may facilitate or offer a function titled or named “intelligent renaming.” A user may, for example, right-click on a file, trigger “intelligent renaming,” and without further input or action from a user, may rename the file based upon tags derived from the document according to one or more of the functions and examples described herein. For example, an “intelligent renaming” function may use information obtained or derived the EXIF data from a JPG image file to rename the file from, for example, “img0701.jpg” to “2012_{—}04_{—}28_{—}2041_{—}2240_x_{—}1680”, which includes information about the date and time on which the image was taken, and a width and height (dimensions) of the image. Such renaming could be automated such that a batch of documents (irrespective of file type) may be renamed. For example, a batch of documents that include rich text format (RTF) documents, JPG images and TIFF images may be processes as a batch. Such renaming allows for more useful names of files with a minimal amount of effort required by a user.

Another exemplary function may also be implemented in association with derived or generated tags. File properties associated with a file may be updated based upon tags derived from the document according to one or more of the functions and examples described herein. For example, one or more of the following properties may be provided with data: title, subject, categories, and author name. Such file properties may be dependent upon the file system used (e.g., Linux, Microsoft Windows).

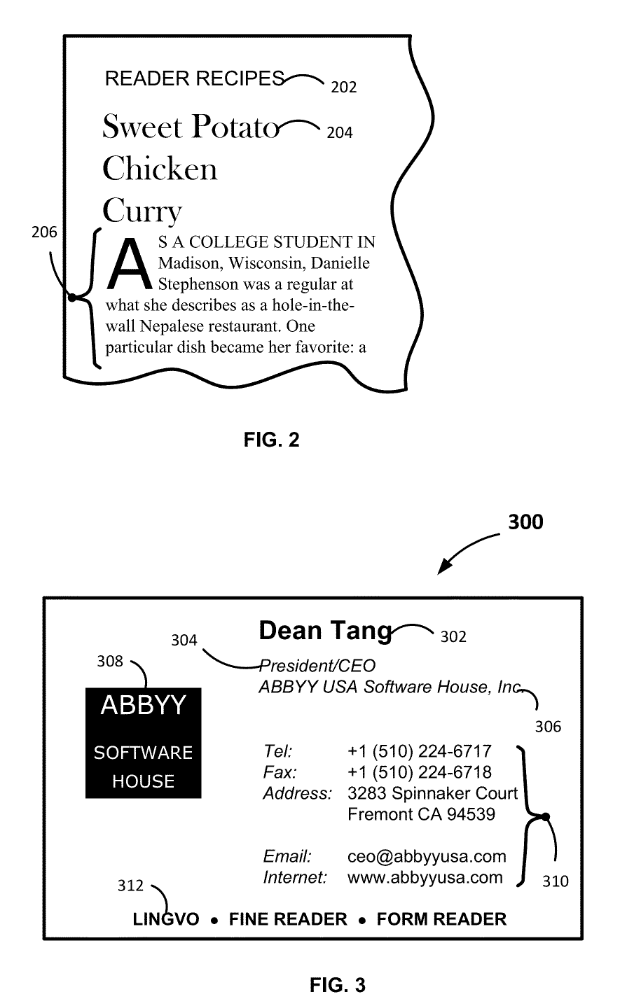

FIG. 2 shows an example of a particular type of document (recipe) from which to extract data for tags. With reference to FIG. 2, a header 202 is present that indicated a title of a section of a newspaper or magazine. In this instance, the header 202 indicates that this document is a recipe. A title 204 indicates the subject or type of recipe. Perhaps later in the body 206 of the recipe ingredients and instructions will be given. From the header 202, title 204 and/or body 206, tags can be generated, and a file name generated. For example, a file name for the image shown in FIG. 2 could be “READER RECIPE Sweet Potato Chicken Curry.tif” Other information (e.g., date, number of pages, one or more ingredients in the recipe) may be included in the name of the file depending on, for example a preconfigured setting or preference(s) set by a user.

FIG. 3 shows an example of another particular type of document (business card 300) from which to extract data for tags. With reference to FIG. 3, a business card includes, for example, a name 302, a title or roll 304, a company name 306, a logo or “bug” (design element) 308, a collection of contact information 310 including labels (e.g., telephone, fax number), and information 312 associated with the business or person. From the various elements of the business card 300, tags can be generated, and a file name generated from the tags or portions thereof. For example, a file name for the image shown in FIG. 2 could be “READER RECIPE Sweet Potato Chicken Curry.tif” Other information (e.g., date, number of pages, one or more ingredients in the recipe) may be included in the name of the file depending on, for example a preconfigured setting or preference(s) set by a user. Broadly, in an exemplary embodiment, the method for generating a file name or file name string comprises the following steps:
I. Definition Stage: is the (input or source) file an electronic document (e.g., DOCX, TXT, etc.) or image (e.g., photo of a document or scanned document—JPG file, TIF file, etc.)?
1. If the input file is an image, then OCR and/or related functions are performed. Optionally, document classification can be performed. During document classification, at least one document type hypothesis is generated (i.e., a type hypothesis about a type of document that corresponds to the document). For each document type hypothesis, classification includes verifying said document type hypothesis including (a) performing a search for tags which are distinctive for this type of document; and (b) selecting a best or most appropriate document type hypothesis.
II. Tag Extraction Stage
   2. If the input file is an electronic document then text and layout information are extracted from it.
   3. The extracted information and, optionally, a selected best document type hypothesis, are used during tag extraction. A tag list is created.
   4. The best or desired tags from the tag list are selected.
   5. A file name string is generated based on the selected tags or other document features.
   6. Optionally, the document is saved with a newly formed name based on the file name string. Saving the document may include saving the identified or derived tags.

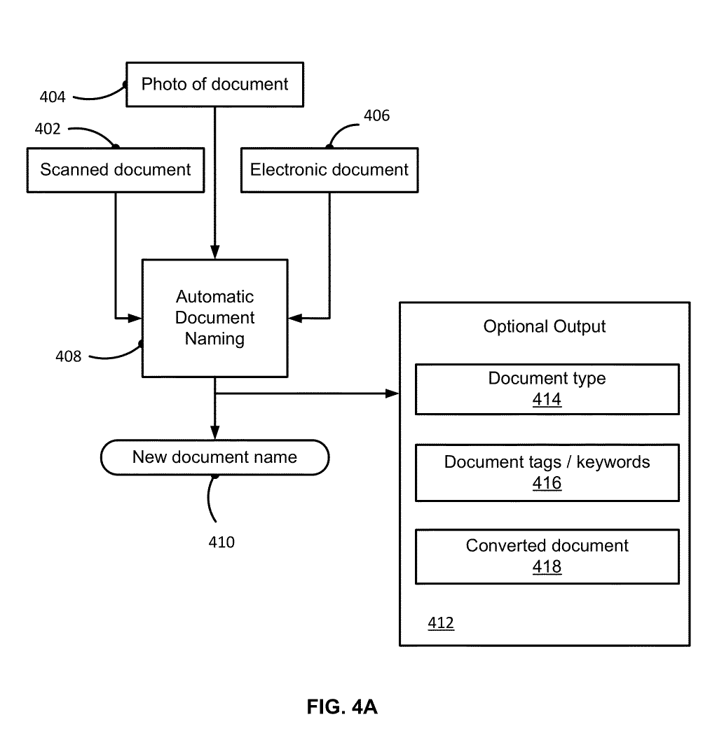

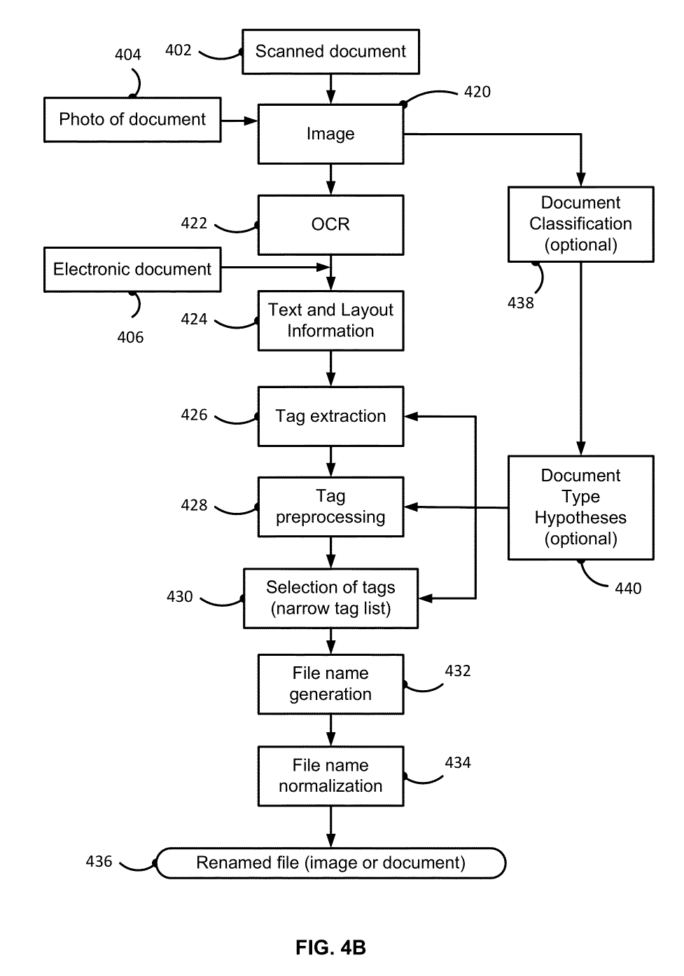

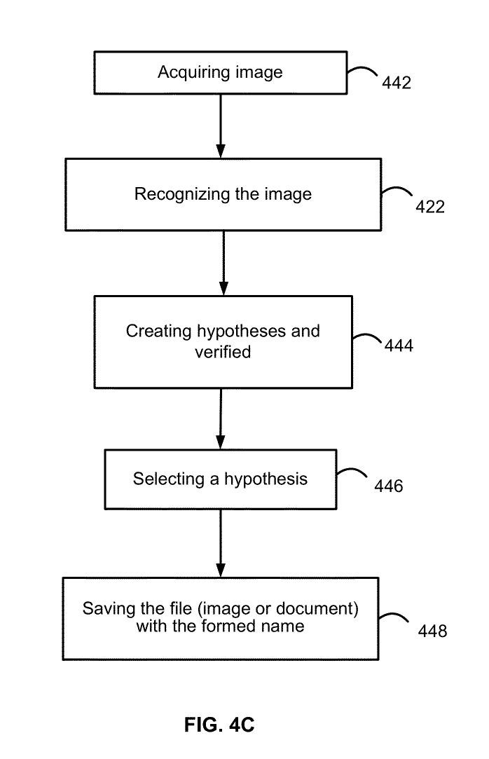

FIG. 4A shows a flowchart in accordance with one implementation of the invention. With reference to FIG. 4A, the method includes taking an image of a document 402, a photo or image of a document 404, or an electronic document 406 and performing an automatic document naming. Such may be done with an automatic document naming component 408 (e.g., programming, logic, computer object code, computer source code, operating system function). A document name 410 is one result of the document naming. Optionally, various data may result from automatic document naming (including tag extraction). The optional output 412 includes one or more document types 414, document tags and/or keywords 416 and a converted document 418.

FIG. 4B shows a flowchart for a detailed algorithm or method in accordance with one embodiment or implementation of the invention. With reference to FIG. 4B, a scan of a document 402 or image that includes a document 404 may be the source of an image 420. An optical character recognition (OCR) and related processing is performed 422 on the image 420. Text and layout information 424 are identified and captured. Alternatively, an electronic document 406 may already include encoded text and may be such electronic document 406 may be processed to acquire text and layout information. Tag extraction 426 is performed to acquire desired information from the text, layout and other information. Tag preprocessing 428 may be performed. In one implementation, tag preprocessing includes normalization of text or file names generated from one or more tags. Normalization includes adjusting text to confirm to an expression that is comfortable for human consumption (e.g., reading, searching). Normalization also includes adjusting text from a variety of tags or derived from a plurality of images to be consistent with one another. For example, a tag that includes “page number 160” can be normalized to “page 160” for the current image and for subsequent (or other) documents. As another example, a url such as “http://www.google.com” can be normalized to “Google”. As another example, an email address, “sergey.marey@abbyy.com” can be normalized to “sergey marey, abbyy”. As another example, a name, “Helen Droval” may be normalized to “H.Droval”. Tag preprocessing can be performed at different times and in different ways. For example, tag extraction can be combined with tag extraction 426, after selection of tags 430 or after file name generation 432.

Selection of tags may include ranking of tags for subsequent file name generation. In a preferred implementation, all extracted tags are ranked. An assigned rank can depend on one or more factors such as a tag type, a document type, presence of other similar tags in the document, presence of other different tags in the document, and a tag's location in the document. One or more tags with a maximal rank are selected. A file name is formed using the selected tags. In one embodiment, an optimal file name is a combination of a group of tags. This group may include two parts. The first part is a “descriptive” and corresponds to a document type description. The second part is a unique or semi-unique part, such as a serial number, or some text that can likely distinguish the file name from hundreds or thousands of other file names. Examples of a two-art file name are “invoice 20_march” or “Business card John Smith, ABBYY”. Several extracted tags (or parts thereof) may be combined when creating a “part” for a two-part file name. In another embodiment, a file name can include only one of the two parts from a two-part file name. For example, a file name may be “20_march” (no ‘descriptive part’) or “invoice” (no unique part). The exact parts used may be automatically determined, or may be based on configurations or preferences available to the name generation algorithms, routines, software, etc.

Returning to FIG. 4B, next, tags are selected 430. The selection of tags 430 may involve selecting a best set of tags, or may involve selecting desired tags (assuming those tags are available for the particular image). At this stage, selection of tags 430 may involve a narrowing of the tag list, and making this list available to a user or to an automated process or program. From the selection of tags, file name generation 432 is performed. For a series or collection of images (documents) or depending on preferences or a configuration setting, file names may be normalized. For example, dates may be put into a standard format (e.g., 2012-09-13). In another example, names may be converted to mixed case (e.g., Marina Selegey where the tag extracted from the document is “MARINA SELEGEY.” After file name normalization 434, the actual electronic file is renamed with the new name 436.

Optionally, the process may involve performing a document classification 438 from the image 420. Document classification 438 is described in further detail herein. Document classification 438 yields one or more document type hypotheses 440. These document type hypotheses, either verified or non-verified, may serve to inform or affect tag extraction 426, tag preprocessing 428, and selection of tags 430. For example, if a tag for a particular image includes the text “recipe” but the document classification returns a high probability (through a document type hypothesis 440) that the image 420 is that of a letter, then during tag selection 430, the method can discard or omit the tag for “recipe” as a candidate for renaming the file (image or document) as a “recipe.”

FIG. 4C shows a flowchart for a method in accordance with another embodiment of the invention. With reference to FIG. 4C, an image is acquired 442. The image is recognized 422 or submitted to one or more processes related to OCR. Then, hypotheses are created 444 (put forward) and are verified. A hypothesis about the image is selected 446. The file is saved with the newly formed name 448; the newly formed name is informed by the hypothesis and recognition.

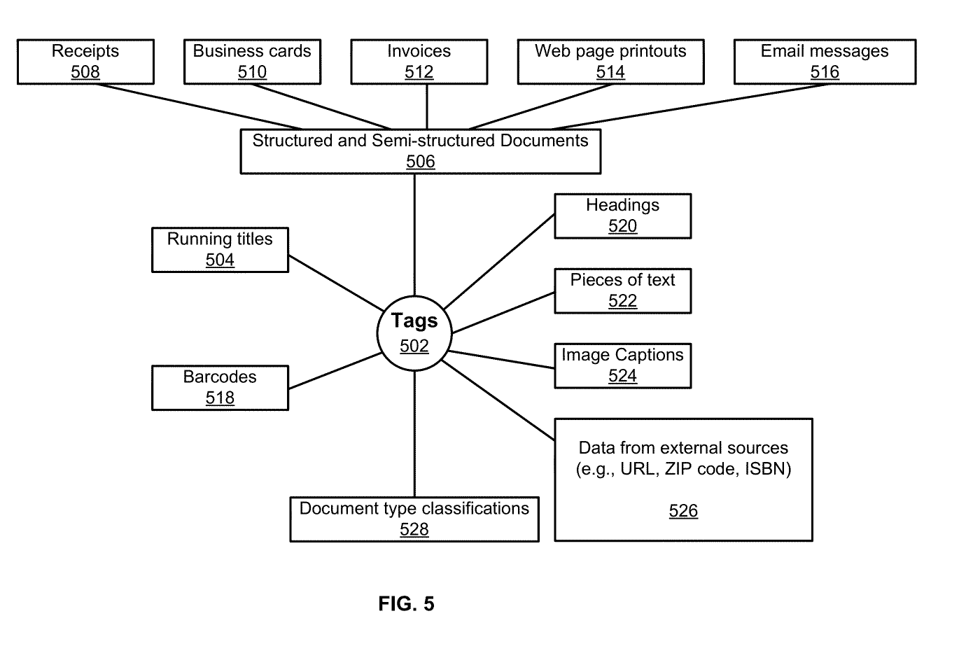

FIG. 5 shows a data structure and set of data derived from a representation of a document or image in accordance with one embodiment of the invention. With reference to FIG. 5, one or more tags 502 may be derived or generated from access to one or more aspects of a document or image. For example, a tag 502 may include information from running titles 504 such as page numbers, author, document title, a URL in a document printout, a data, a title of a document sent by fax, and so on. Data for tags 502 may also come from information derived from structured and semi-structured documents 506. Examples of such documents include: receipts 508, business cards 510, invoices 512, Web page printouts 514, email messages 516. Data for tags 502 may also come from barcodes 518 and information derived from barcodes 518. For example, a QR code may encode or lead to a URL, which in turn may lead to a Web page from which may be captured a title, date of creation, author, etc. Data for tags 502 may also come from headings, subheadings, chapter headings and other features of documents. Data for tags 502 may also come from miscellaneous pieces of text, for example dates, keywords, repeated words, and words associated with standard structural features of a document. Examples of structural features of a document may include the “subject” line of a formal letter; a name associated with a signature line of a letter; a date stamped or found in a footer, header or signature line of a letter. Data for tags 502 may also come from captions 524 or other text associated with an image identified on a particular page of a document. Data for tags 502 may also come from data derived from sources external from the document 526. Examples of such external data include EAN barcodes, ISBN's, ZIP codes and URL's. Each of these examples may lead to other information—examples are, respectively, a product name, a book title, a city name, and a Web page title field. Data for tags 502 may also come from results from document type classification 528. Examples of classifications are: receipt, business card, newspaper, agreement, and magazine. Each of these labels or classes of documents may then be used as a tag or as part of a tag.

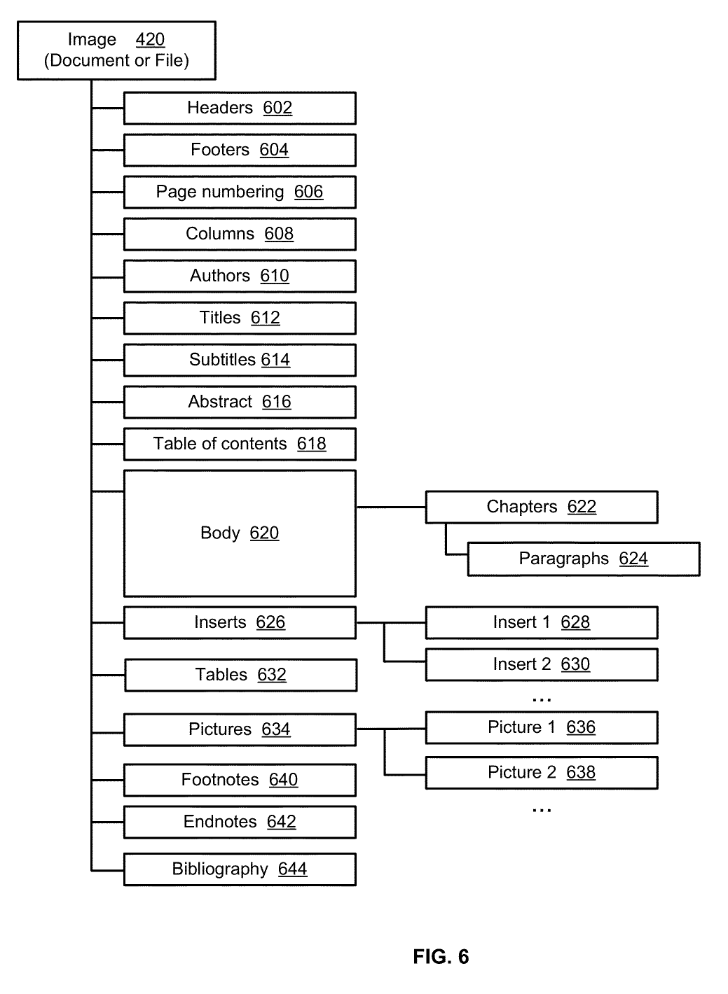

FIG. 6 shows a composite data structure derived from a representation of a generic or universal-like file (document or image) in accordance with another embodiment of the invention. With reference to FIG. 6, an image (or file or document) 420 may be analyzed, such as by OCR and related algorithms, and found to have one or more features (e.g., data structures). The features include, for example, headers 602, footers 604, page numbering 606, columns 608, authors 610, titles 612, subtitles 614, an abstract 616, a table of contents 618, and body 620. The body 620 may include such features as chapters 622 and paragraphs 624 or other types of text units. The features of a file may also include inserts 626 (or overlays) and each insert may have other inserts such as represented in FIG. 6 as Insert 1 (628) and Insert 2 (630). The features of a file may also include tables 632, pictures 634, footnotes 640, endnotes 642 and a bibliography 644. From an evaluation a picture 634, the particular picture may include a “picture within a picture.” Therefore, a picture 634 may include sub pictures represented as Picture 1 (636) and Picture 2 (638). Other features may be found in a file 420.

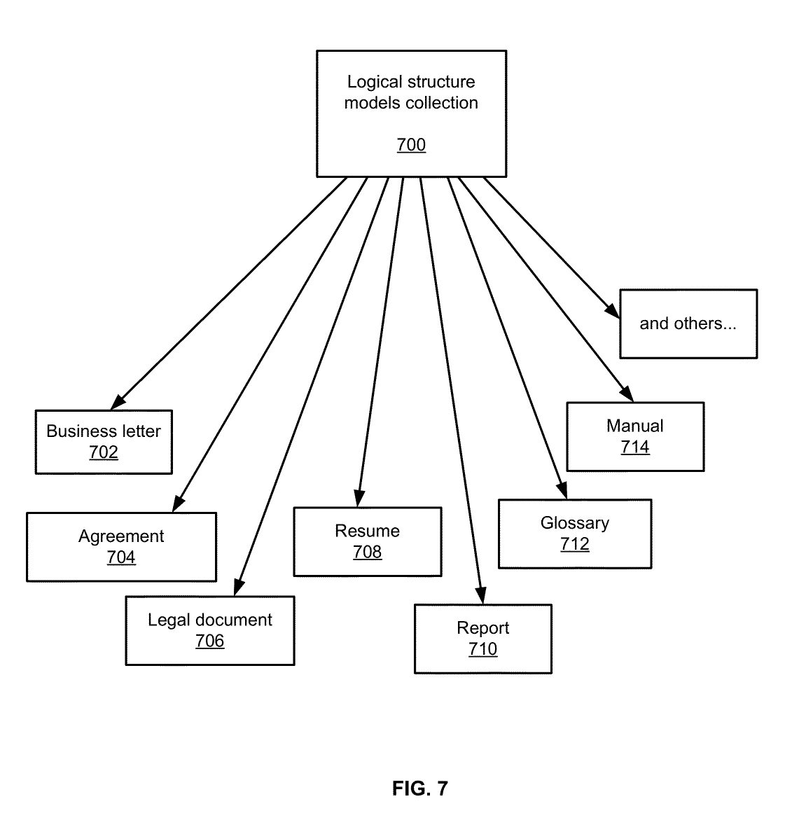

FIG. 7 shows a variety of document types that may be derived from data associated or derived from a representation of a document in accordance with an embodiment of the invention. These document types may be placed into a collection of logical structure models such as that collection shown in FIG. 4D. With reference to FIG. 7, a collection of logical structure models 700 may include a business letter 702, an agreement 704, a legal document 706, a resume 708, a report 710, a glossary 712, a manual 714, and others.

In one embodiment, the system comprises an imaging device connected to a computer programmed with specially designed OCR (ICR) software, functionality, algorithms or the like. The system is used to scan a paper-based document (source document) or to make a digital photo of it so as to produce a document image thereof. In another embodiment, such document image may be made with a digital camera (or mobile phone, smart phone, tablet computer and the like), received through a medium such as e-mail, captured from or with a software application, or obtained from an online OCR Web-based service.

Any given document may have several specific fields and form elements. For example, a document may have several titles, subtitles, headers and footers, an address, a registration number, an issue date field, a reception date field, page numbering, etc. Some of the titles may have one of several pre-defined specified values, for example: Invoice, Credit Note, Agreement, Assignment, Declaration, Curriculum Vitae, Business Card, etc. Other documents may include such identifying words as “Dear . . . ”, “Sincerely yours” or “Best regards.” The presence of these words coupled with their characteristic location on a page will often allow the system to classify the document as belonging to a particular type (e.g., personal letter, business letter).

Apart from the unique features typical of the given document type, the document may include unique values corresponding to respective unique features, for example: invoice number, credit note number, a date of the agreement, signatories to the assignment, the name of the person submitting the curriculum vitae, or the name of the holder of the business card person, etc. In one embodiment, the OCR software compares a value with descriptions of possible types available to the software in order to generate a hypothesis about the type of the source document. Then the hypothesis is verified and the recognized text is transformed to reproduce the native formatting of the source document. After processing, recognized text may be exported into an extended editable document format, for example, Microsoft Word format, rich text format (RTF), or Tagged PDF, and may be given a unique name based on the identified document type and its unique features. For example, “Invoice.sub.-#880,” “Credit Note.sub.-888,” “Agreement.sub.-543,” “Agreement.sub.-543_page 1,” “Agreement.sub.-543_page 2,” “Agreement.sub.-12.03.2009,” “Curriculum Vitae_Yan Allen,” “Business Card_Yan Allen,” “Letter to_Mr. Smith,” “Letter from_Mr. Smith,” etc.

In another embodiment, the logical structure of the document is recognized and is used to arrive at conclusions about the style and a possible name for the recognized document. For example, the system may determine whether it is a business letter, a contract, a legal document, a certificate, an application, etc. The system recognizes the document and checks how well each of the generated hypotheses correspond to the actual properties of the document. The system evaluates each hypothesis based on a degree of correspondence between the hypothesis and the information, properties or tags extracted from the document. The hypothesis with the highest correlation with the actual properties of the document is selected.

In order to process a document image, in one embodiment, the system is provisioned with information about specific words which may be found and the possible mutual arrangement of form elements. As noted above, the form elements include elements such as columns (main text), headers and footers, endnotes and footnotes, an abstract (text fragment below the title), headings (together with their hierarchy and numbering), a table of contents, a list of figures, bibliography, the document's title, the numbers and captions of figures and tables, etc.

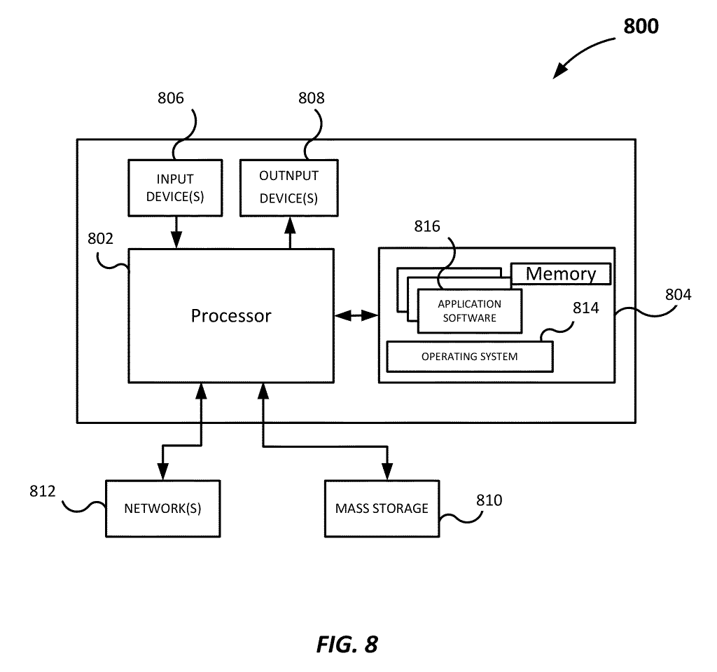

FIG. 8 of the drawings shows an example of hardware 800 that may be used to implement the system, in accordance with one embodiment of the invention. The hardware 800 typically includes at least one processor 802 coupled to a memory 804. The processor 802 may represent one or more processors (e.g., microprocessors), and the memory 804 may represent random access memory (RAM) devices comprising a main storage of the hardware 800, as well as any supplemental levels of memory, e.g., cache memories, non-volatile or back-up-memories (e.g. programmable or flash memories), read-only memories, etc. In addition, the memory 804 may be considered to include memory storage physically located elsewhere in the hardware 800, e.g. any cache memory in the processor 802 as well as any storage capacity used as a virtual memory, e.g., as stored on a mass storage device 810.

The hardware 800 also typically receives a number of inputs and outputs for communicating information externally. For interface with a user or operator, the hardware 800 may include one or more user input devices 806 (e.g., a keyboard, a mouse, imaging device, scanner, etc.) and a one or more output devices 808 (e.g., a Liquid Crystal Display (LCD) panel, a sound playback device (speaker).

For additional storage, the hardware 800 may also include one or more mass storage devices 810, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 800 may include an interface with one or more networks 812 (e.g., a local area network (LAN), a wide area network (WAN), a wireless network, and/or the Internet among others) to permit the communication of information with other computers coupled to the networks. It should be appreciated that the hardware 800 typically includes suitable analog and/or digital interfaces between the processor 802 and each of the components 804, 806, 808, and 812 as is well known in the art.

The hardware 800 operates under the control of an operating system 814, and executes various computer software applications, components, programs, objects, modules, etc. to implement the techniques described above. Moreover, various applications, components, programs, objects, etc., collectively indicated by reference 816 in FIG. 8, may also execute on one or more processors in another computer coupled to the hardware 800 via a network 812, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks, (DVDs), etc.).

In the previous description, for purposes of explanation, numerous specific details are set forth in order to provide an understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

We claim:

1. A method for naming an electronic file, the method comprising:
identifying a tag related to the electronic file from components of the electronic file;
creating document type hypotheses for the electronic file;
verifying each of the document type hypotheses;
calculating and assigning a rating value to each document type hypothesis;
selecting a document type hypothesis based on said rating values of the document type hypotheses;
forming a file name string based on said selected document type hypothesis; and
saving in a computer readable medium a file name based on said formed file name string.

2. The method of claim 1, wherein the method further comprises:
prior to creating the document type hypotheses, performing optical character recognition (OCR) on the electronic file, wherein OCR includes generating encoded text from the electronic file;
prior to creating the document type hypotheses, identifying a tag related to the electronic file from components of the electronic file; and
creating the document type hypotheses based on the identified tag.

3. The method of claim 2, wherein the method further comprises:
saving in the computer readable medium the newly generated encoded text along with information from the electronic file in a new version of the electronic file.

4. The method of claim 1, wherein creating the document type hypothesis includes basing the document type hypothesis on non-tag features of the electronic file.

5. The method of claim 1, wherein the method further comprises:
after identifying tags related to the electronic file, creating a list of extracted tags, and wherein said forming the file name string is based on a plurality of the extracted tags included in the list of extracted tags.

6. The method of claim 1, wherein forming the file name string comprises forming the file name string based on information derived from a layout of the electronic file.

7. The method of claim 1, wherein forming the file name string includes forming a semi-unique file name string from a semi-unique value associated with the electronic file.

8. The method of claim 1, wherein the file name string is based on a normalized sequence of characters based on a document type corresponding to the document type hypothesis.

9. The method of claim 1, wherein the method further comprises:
identifying a logical structure of the electronic file, wherein the file name string is based on the identified logical structure of the electronic file.

10. The method of claim 1, wherein the method further comprises identifying a model from a plurality of pre-defined models and wherein the file name string is based on said identified model.

11. An electronic device for facilitating naming of an electronic file, the device comprising:
a processor;
a memory in electronic communication with the processor, the memory configured with instructions for performing a method, the method including:
identifying tags related to the electronic file from components of the electronic file;
identifying a logical structure of the electronic file;
forming a file name string based on one or more of said tags and logical structure of the electronic file; and
saving in said memory the file name.

12. The electronic device of claim 11, wherein the method further comprises:
creating a first document type hypothesis for the electronic file based on the identified tags;
attempting to verify the first document type hypothesis;
when the first document type hypothesis is not verified, creating a second document type hypothesis;
forming the file name string based on said first document type hypothesis or said second document type hypothesis.

13. The electronic device of claim 11, wherein the electronic device further comprises an electronic display, and wherein the tags are displayed on the electronic display, and wherein the method further comprises:
detecting selection of one or more tags through one or more user interface elements, and wherein forming the file name string is further based on said detected selection.

14. The electronic device of claim 11, wherein creating the second document type hypothesis includes basing the second document type hypothesis on non-tag features of the electronic file.

15. The electronic device of claim 11, wherein forming the file name string comprises:
forming the file name string based on information derived from a layout of the electronic file.

16. The electronic device of claim 11, wherein the file name string is based on a normalized sequence of characters based on a document type corresponding to the document type hypothesis.

17. A method for naming an electronic file, the method comprising:
identifying tags related to the electronic file from components of the electronic file;
identifying an attribute of the electronic file;
forming a file name string based on one or more of said tags and attribute of the electronic file; and
saving in said memory the file name.

18. The method of claim 17, wherein the method further comprises:
creating a first document type hypothesis for the electronic file based on the identified tags;
attempting to verify the first document type hypothesis;
when the first document type hypothesis is not verified, creating a second document type hypothesis;
forming the file name string based on said first document type hypothesis or said second document type hypothesis.

19. The method of claim 17, wherein creating the second document type hypothesis includes basing the second document type hypothesis on non-tag features of the electronic file.

20. The method of claim 18, wherein the file name string is based on a normalized sequence of characters based on a document type corresponding to the document type hypothesis.
